(19) United States
(12) Patent Application Publication
(10) Pub. No.: US 2025/0047044 A1
(43) Pub. Date: Feb. 6, 2025

(54) CONNECTOR PANEL

(71) Applicant: Mitsubishi Electric Corporation, Tokyo (JP)

(72) Inventors: Yoshiyuki KUSANO, Tokyo (JP); Kyota OTSUKA, Tokyo (JP)

(73) Assignee: Mitsubishi Electric Corporation, Tokyo (JP)

(21) Appl. No.: 18/918,275

(22) Filed: Oct. 17, 2024

Related U.S. Application Data
(63) Continuation of application No. PCT/JP2022/019553, filed on May 6, 2022.

(51) Int. Cl. H01R 13/74

(52) U.S. Cl. CPC H01R 13/748

(57) ABSTRACT

A connector panel includes: a disk-shaped panel to which connectors each having a first end protruding to one side and a second end protruding to another side is attached, the panel having a first screw on an outer periphery; an attachment having a first cylindrical portion and a flange at a second end of the first cylindrical portion, the flange being fixed to an edge of an opening formed in a structure shielding an inside from an outside, and having a second screw at a first end of an outer periphery of the first cylindrical portion; and a holder having a third screw into which the first screw is screwed at a first end of an inner periphery and a fourth screw into which the second screw is screwed at a second end of the inner periphery, and having a second cylindrical portion being coaxial with the first cylindrical portion.

### CROSS REFERENCE TO RELATED APPLICATION

This application is a Continuation of PCT International Application No. PCT/JP2022/019553, filed on May 6, 2022, which is hereby expressly incorporated by reference into the present application.

### TECHNICAL FIELD

The present disclosure relates to a connector panel attached to a structure shielding an inside from an outside and having a plurality of connectors.

### BACKGROUND ART

Patent Literature 1 discloses a screw fastening type connector in which male and female screw structures having different diameters are screwed into each other by a connection attachment of a screw structure connecting the screw structures.

Meanwhile, in order to connect an outside and an inside of a shielded closed space such as an anechoic chamber by a plurality of signal cables or the like, it is considered that instead of individually attaching a plurality of connectors to a structure shielding an inside from an outside, such as a wall surface for shielding, the inside and the outside of the structure are connected to each other by a plurality of signal cables or the like while a shielding property (shielding performance) is ensured by forming an opening in the structure and attaching a connector panel having a plurality of connectors to the opening of the structure.

### CITATION LIST

### Patent Literature

Patent Literature 1: JP 07-130427 A

### SUMMARY OF INVENTION

### Technical Problem

Even when the plurality of connectors in the connector panel attached to the opening of the structure are the screw fastening type connectors disclosed in Patent Literature 1, fastening as the connectors is improved, but the following points are desired as the connector panel.

That is, it is desirable to ensure a shielding property when the connector panel is attached to the opening of the structure, and to easily perform work of detaching the connector panel from the structure and work of attaching the detached connector panel to the structure when maintenance of cables connected to the plurality of connectors is performed.

The present disclosure has been made in view of the above points, and an object of the present disclosure is to obtain a connector panel that ensures a shielding property (shielding performance) and facilitates work of detaching a panel base to which a plurality of connectors is attached and work of attaching the detached panel base.

### Solution to Problem

A connector panel according to the present disclosure includes: a panel base having a disk shape to which a plurality of connectors is attached, the plurality of connectors each having a first end protruding to a side of a first surface of the panel base and a second end protruding to a side of a second surface of the panel base, the panel base having a first screw portion on its outer peripheral surface; an attachment body having a first cylindrical portion and a flange formed integrally with the first cylindrical portion at a second end of the first cylindrical portion, the flange being configured to be fixed to an edge of an opening formed in a structure shielding an inside from an outside, and having a second screw portion at a first end of an outer peripheral surface of the first cylindrical portion; and a holding body having a third screw portion into which the first screw portion of the panel base is screwed at a first end of an inner peripheral surface of the holding body and a fourth screw portion into which the second screw portion of the attachment body is screwed at a second end of the inner peripheral surface, and having a second cylindrical portion whose center axis coincides with a center axis of the first cylindrical portion of the attachment body.

### Advantageous Effects of Invention

According to the present disclosure, since the panel base to which the plurality of connectors is attached is attached to the attachment body fixed to one surface of the structure via the holding body, work of detaching the panel base from the attachment body and work of attaching the panel base to the attachment body are easy while shielding performance to the structure is ensured.

### BRIEF DESCRIPTION OF DRAWINGS

FIG. 1 is a perspective view illustrating a connector panel according to a first embodiment.

FIG. 2 is a cross-sectional view cut along a line A-A in FIG. 1.

FIG. 3 is a perspective view illustrating a holding body in the connector panel according to the first embodiment.

FIG. 4 is a main part enlarged cross-sectional view illustrating an arrangement state of the connector panel according to the first embodiment before screwing.

FIG. 5 is a main part enlarged cross-sectional view illustrating an arrangement state of the connector panel according to the first embodiment in a middle stage of screwing.

FIG. 6 is a main part enlarged cross-sectional view illustrating a screwed state of the connector panel according to the first embodiment after screwing.

FIG. 7 is a main part enlarged cross-sectional view illustrating a pressing state of the connector panel according to the first embodiment after screwing.

FIG. 8 is a main part enlarged cross-sectional view illustrating a pressing state of a connector panel according to a second embodiment after screwing.

FIG. 9 is a main part enlarged cross-sectional view illustrating a pressing state of a connector panel according to a third embodiment after screwing.

FIG. 10 is a main part enlarged cross-sectional view illustrating a pressing state of a connector panel according to a fourth embodiment after screwing.

FIG. 11 is a main part enlarged cross-sectional view illustrating a pressing state of a connector panel according to a fifth embodiment after screwing.

FIG. 12 is a main part enlarged cross-sectional view illustrating an arrangement state of a connector panel according to a sixth embodiment before screwing.

FIG. 13 is a main part enlarged cross-sectional view illustrating an arrangement state of the connector panel according to the sixth embodiment in a middle stage of screwing.

FIG. 14 is a main part enlarged cross-sectional view illustrating a screwed state of the connector panel according to the sixth embodiment after screwing.

FIG. 15 is a main part enlarged cross-sectional view illustrating a screwed state of a connector panel according to a seventh embodiment after screwing.

FIG. 16 is a main part enlarged cross-sectional view illustrating a screwed state of a connector panel according to an eighth embodiment after screwing.

FIG. 17 is a main part enlarged cross-sectional view illustrating a screwed state of a connector panel according to a ninth embodiment after screwing.

FIG. 18 is a main part enlarged cross-sectional view illustrating a screwed state of a connector panel according to a tenth embodiment after screwing.

### DESCRIPTION OF EMBODIMENTS

### First Embodiment

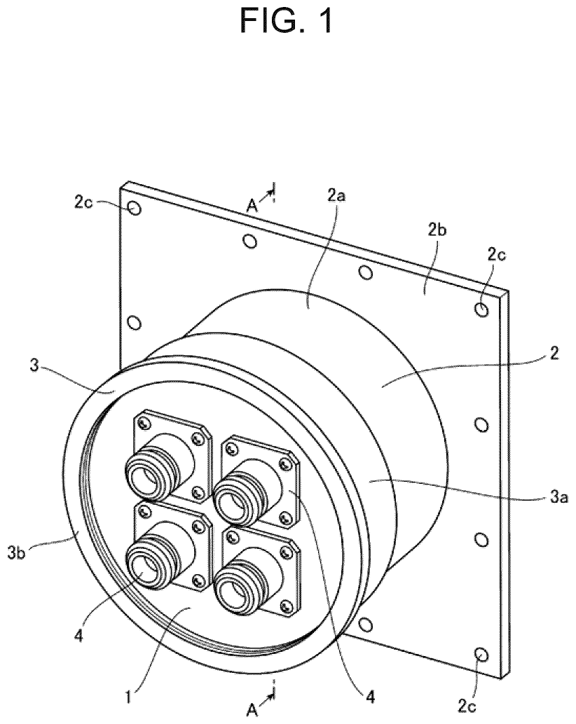

A connector panel according to a first embodiment will be described with reference to FIGS. 1 to 7.

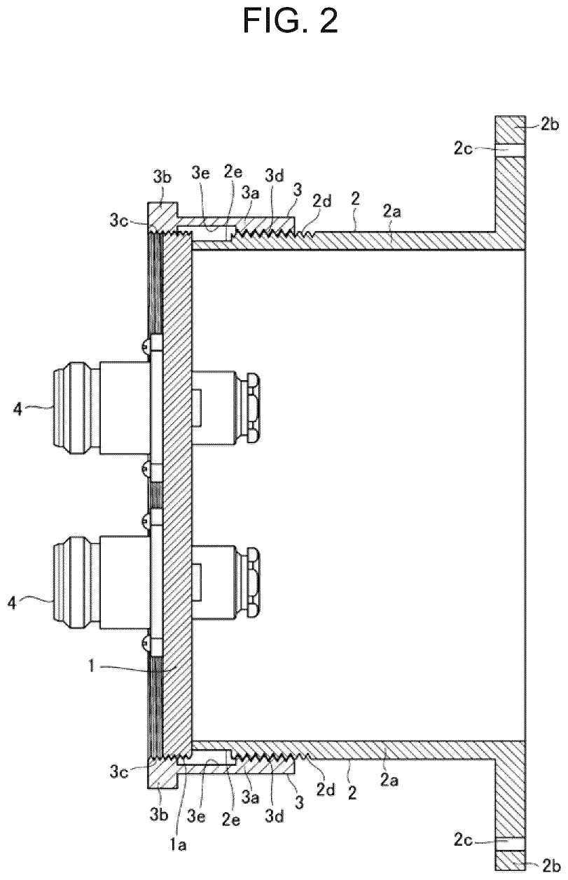

As illustrated in FIGS. 1 and 2, the connector panel includes a panel base 1, an attachment body 2, a holding body 3, and a plurality of connectors 4.

The connector panel is attached to a structure (not illustrated) that is a wall shielding an inside of a shielded closed space such as an anechoic chamber from an outside thereof. When the connector panel is attached to a cylindrical through hole formed in the wall which is the structure, in the first embodiment, a front surface side is defined as the outside of the anechoic chamber, and a back surface side is defined as the inside of the anechoic chamber.

The panel base 1 is a disk-shaped conductive member having a first screw portion 1a formed on an outer peripheral surface thereof.

The first screw portion 1a is a parallel male screw.

To the panel base 1, the plurality of connectors 4 each having a first end protruding to one surface (hereinafter, referred to as a first surface) side which is the front surface side, and a second end protruding to the other surface (hereinafter, referred to as a second surface) side which is the back surface side is attached.

Although not illustrated, a port connecting the inside and the outside of the anechoic chamber, such as a through pipe passing through the panel base 1 from the front surface side to the back surface side, is formed in the panel base 1.

Each of the plurality of connectors 4 has an outer shape portion formed of a conductive member for shielding, is fixed to the panel base 1 by screw clamp at four corners, and is set to the same potential as the panel base 1, that is, a ground potential.

In addition, a first harness cable (not illustrated) such as a signal cable is connected to a first terminal disposed at the first end of each of the plurality of connectors 4, and a second harness cable (not illustrated) such as a signal cable is connected to a second terminal disposed at the second end of each of the plurality of connectors 4.

Each of the plurality of connectors 4 is an N-type connector that electrically connects the first harness cable and the second harness cable disposed outside and inside the wall which is the structure constituting the anechoic chamber to each other.

The number of connectors 4 is four as an example, but is not limited to four.

In addition, each of the connectors 4 is fixed to the panel base 1 by screw clamp, but a periphery of each of the connectors 4 may be formed into a screw structure, and each of the connectors 4 may be screwed into and fixed to the panel base 1.

The attachment body 2 has a first cylindrical portion 2a and a first flange 2b formed integrally with the first cylindrical portion 2a at a second end of the first cylindrical portion 2a. The attachment body 2 is a conductive member and is grounded.

The first cylindrical portion 2a is inserted from an inside of the structure into an opening formed in the structure with an outer peripheral surface thereof in close contact with the opening.

The first flange 2b has a plurality of screw through holes 2c formed at equal intervals along a periphery, and is fixed at many points by screws passing through the screw through holes 2c at an edge of the opening formed in the structure, that is, an edge on an inner surface side of the opening formed in the wall which is the structure.

Note that attaching the attachment body 2 to the structure is not limited to a configuration in which the first cylindrical portion 2a is inserted into the opening formed in the structure with an outer peripheral surface thereof in close contact with the opening, and the first flange 2b is fixed to the edge on the inner surface side of the opening.

For example, attaching the attachment body 2 to the structure may have a configuration in which an inner diameter of the first cylindrical portion 2a is the same as an inner diameter of the opening formed in the structure, the first cylindrical portion 2a is disposed outside the structure in communication with the opening, and the first flange 2b is fixed to an edge on an outer surface side of the opening.

The first cylindrical portion 2a has a second screw portion 2d formed at a first end of the outer peripheral surface located on a side opposite to the first flange 2b.

The second screw portion 2d is a parallel male screw.

The first cylindrical portion 2a has a first end surface in close contact with a second surface of the panel base 1 at a first end thereof, and has an even circumferential surface 2e on an outer peripheral surface between the first end surface and the second screw portion 2d.

The portion of the first cylindrical portion 2a having the even circumferential surface 2e serves as a buffer body when the first end surface of the first cylindrical portion 2a and the second surface of the panel base 1 are firmly in close contact with each other.

That is, the portion of the first cylindrical portion 2a having the even circumferential surface 2e serves as a buffer body that applies a pressing force to the first cylindrical portion 2a in a second direction along a center axis and applies a pressing force to the panel base 1 in a first direction along the center axis.

Since the attachment body 2 is fixed to the opening formed in the structure and grounded, a shielding property is ensured, and the second harness cable inserted into an inside is shielded by the first cylindrical portion 2a.

The holding body 3 attaches the panel base 1 to the attachment body 2 by being screwed into each of the panel base 1 and the attachment body 2 between the panel base 1 and the attachment body 2.

The holding body 3 is a conductive member, is grounded by the attachment body 2, and grounds the panel base 1.

As a result, since the panel base 1, the attachment body 2, and the holding body 3 are electrically connected to each other and grounded, shielding performance is satisfied.

As illustrated in FIGS. 2 and 3, the holding body 3 has a second cylindrical portion 3a communicating with the first cylindrical portion 2a of the attachment body 2, and a second flange 3b formed integrally with the second cylindrical portion 3a at a first end of the second cylindrical portion 3a.

A center axis of the second cylindrical portion 3a of the holding body 3 coincides with a center axis of the first cylindrical portion 2a of the attachment body 2.

The holding body 3 has a third screw portion 3c into which the first screw portion 1a of the panel base 1 is screwed at a first end of an inner peripheral surface thereof, and a fourth screw portion 3d into which the second screw portion 2d of the attachment body 2 is screwed at a second end of the inner peripheral surface.

The holding body 3 has an even circumferential surface 3e between the third screw portion 3c and the fourth screw portion 3d on the inner peripheral surface.

The portion of the holding body 3 having the even circumferential surface 3e is a boundary between the third screw portion 3c and the fourth screw portion 3d.

The third screw portion 3c in the holding body 3 is a parallel female screw extending from a first end surface of the third screw portion 3c to a first end of the even circumferential surface 3e.

The fourth screw portion 3d in the holding body 3 is a parallel female screw extending from a second end of the even circumferential surface 3e to a second end surface of the fourth screw portion 3d.

The third screw portion 3c has the same screw size as the first screw portion 1a of the panel base 1.

The fourth screw portion 3d has the same screw size as the second screw portion 2d of the attachment body 2.

Screwing of the first screw portion 1a in the panel base 1 and the third screw portion 3c in the holding body 3 is in a direction opposite to screwing of the second screw portion 2d in the attachment body 2 and the fourth screw portion 3d in the holding body 3.

That is, screwing of the first screw portion 1a and the third screw portion 3c and screwing of the second screw portion 2d and the fourth screw portion 3d have a relationship of a left screw and a right screw.

A screw diameter of the first screw portion 1a and the third screw portion 3c is the same as a screw diameter of the second screw portion 2d and the fourth screw portion 3d.

A screw pitch of the first screw portion 1a and the third screw portion 3c is shorter than a screw pitch of the second screw portion 2d and the fourth screw portion 3d.

The screw pitch of the first screw portion 1a and the third screw portion 3c may be the same as or longer than the screw pitch of the second screw portion 2d and the fourth screw portion 3d.

Since the screw pitch of the first screw portion 1a and the third screw portion 3c is preferably shorter than the screw pitch of the second screw portion 2d and the fourth screw portion 3d, the following description will be given on the basis of an example in which the screw pitch of the first screw portion 1a and the third screw portion 3c is shorter than the screw pitch of the second screw portion 2d and the fourth screw portion 3d.

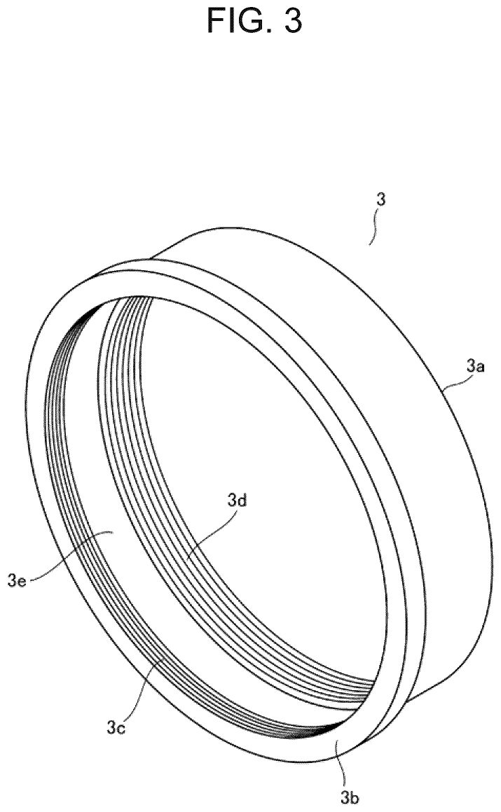

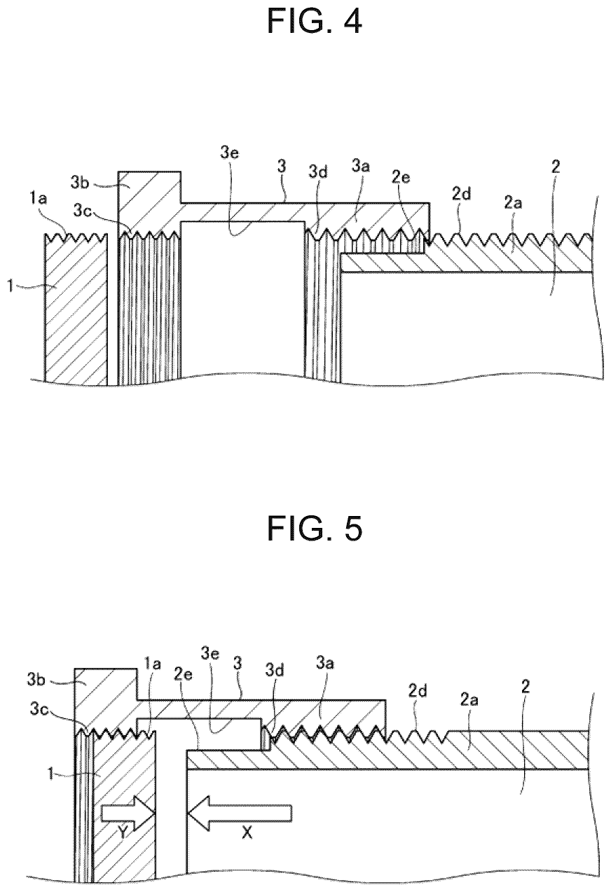

Next, how to attach the connector panel according to the first embodiment to the opening which is the through hole of the wall which is the structure in the anechoic chamber will be described with reference to FIGS. 4 to 6.

First, the attachment body 2 is fixed to the opening formed in the wall.

That is, the first cylindrical portion 2a of the attachment body 2 is inserted from an inside of the wall into the opening with an outer peripheral surface thereof in close contact with the opening, and the first flange 2b is fixed to an inner surface of the wall which is an edge of the opening by screw clamp by causing a screw to pass through the screw through hole 2c.

Next, as illustrated in FIG. 4, an open end of the holding body 3 on a second end side and an open end of the attachment body 2 on a first end side are caused to face each other in such a manner that center axes thereof coincide with each other, the fourth screw portion 3d of the holding body 3 is pressed against the second screw portion 2d of the attachment body 2, and the holding body 3 is rotated clockwise.

Then, the fourth screw portion 3d is screwed into the second screw portion 2d, and the holding body 3 is temporarily attached to the attachment body 2.

In this state, a back surface which is a second end side of the panel base 1 and an open end of the holding body 3 on a first end side are caused to face each other in such a manner that center axes thereof coincide with each other, the first screw portion 1a of the panel base 1 is pressed against the third screw portion 3c of the holding body 3, and the holding body 3 is rotated clockwise.

Then, the third screw portion 3c is screwed into the first screw portion 1a, and the panel base 1 is temporarily attached to the holding body 3.

Although not illustrated in FIG. 4, the second harness cable is connected to a second terminal disposed at the second end of each of the plurality of connectors 4 attached to the panel base 1.

In this state, only the holding body 3 is rotated clockwise without rotating the panel base 1.

FIG. 5 illustrates an arrangement state of the panel base 1, the attachment body 2, and the holding body 3 in a middle stage of rotating the holding body 3 clockwise.

Since the fourth screw portion 3d and the second screw portion 2d each have a right screw structure, the holding body 3 moves to a second end side of the attachment body 2. In other words, a first end surface of the first cylindrical portion 2a in the attachment body 2 relatively advances in a direction of a second surface of the panel base 1, that is, a direction of an arrow X in FIG. 5.

Meanwhile, since the first screw portion 1a and the third screw portion 3c each have a left screw structure, the panel base 1 advances to a first end side of the attachment body 2, that is, in a direction of an arrow Y in FIG. 5.

In short, when only the holding body 3 is rotated clockwise without rotating the panel base 1, the holding body 3 and the panel base 1 move to the second end side of the attachment body 2 in a direction in which the second surface of the panel base 1 and the first end surface of the first cylindrical portion 2a in the attachment body 2 approach each other.

At this time, when a screw pitch of the first screw portion 1a and the third screw portion 3c is shorter than a screw pitch of the second screw portion 2d and the fourth screw portion 3d, a moving distance of the panel base 1 with respect to the holding body 3 can be shorter than a moving distance of the holding body 3 with respect to the attachment body 2, and the second surface of the panel base 1 can be brought into close contact with the first end surface of the first cylindrical portion 2a in the attachment body 2 without moving the panel base 1 deep into the holding body 3.

In addition, since the panel base 1 is not rotated when the panel base 1 is attached, the second harness cable connected to each of the plurality of connectors 4 is not twisted.

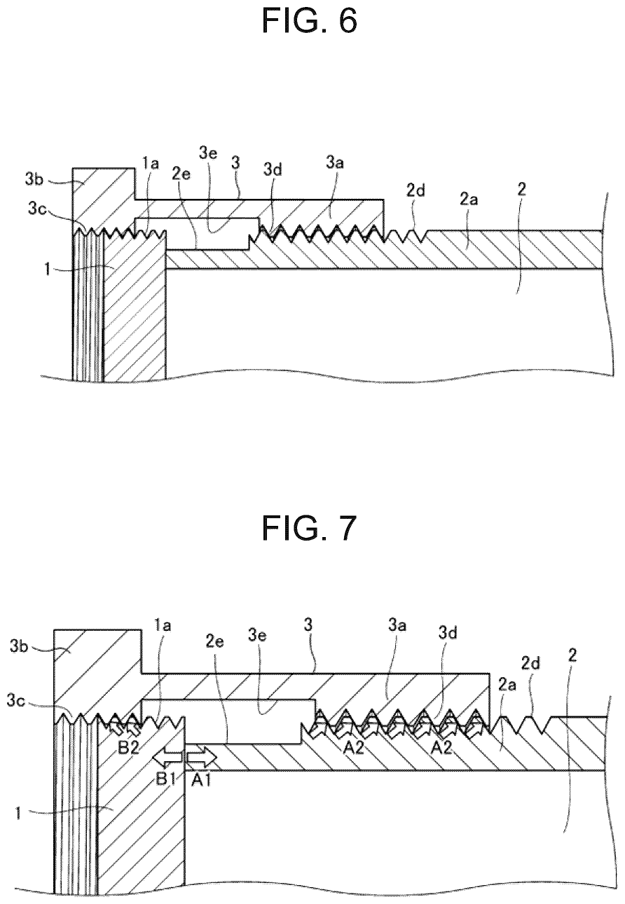

FIG. 6 illustrates a final stage in which the panel base 1 is attached to the attachment body 2 via the holding body 3.

As illustrated in FIG. 6, the second surface of the panel base 1 is in close contact with the first end surface of the first cylindrical portion 2a in the attachment body 2.

When only the holding body 3 is further slightly rotated clockwise in the close contact state, as illustrated in FIG. 7, the portion of the first cylindrical portion 2a in the attachment body 2 having the even circumferential surface 2e applies a pressing force to the first cylindrical portion 2a in a second direction along the center axis, that is, a direction of an arrow A1 in FIG. 7, and applies a pressing force to the panel base 1 in a first direction along the center axis, that is, a direction of an arrow B1 in FIG. 7, by a repulsive force of the portion of the first cylindrical portion 2a.

As a result, the second screw portion 2d of the first cylindrical portion 2a in the attachment body 2 applies a pressing force to the fourth screw portion 3d of the holding body 3 in a second direction, that is, a direction of an arrow A2 in FIG. 7, and the first screw portion 1a of the panel base 1 applies a pressing force to the third screw portion 3c of the holding body 3 in a first direction, that is, a direction of an arrow B2 in FIG. 7.

Therefore, the second surface of the panel base 1 and the first end surface of the first cylindrical portion 2a in the attachment body 2 are firmly in close contact with each other, and shielding performance between the panel base 1 and the holding body 3 and shielding performance between the attachment body 2 and the holding body 3 are high. As a result, shielding performance between the panel base 1 and the attachment body 2 is high.

By rotating only the holding body 3 clockwise, both the holding body 3 and the panel base 1 move to the second end side of the attachment body 2, and the second surface of the panel base 1 and the first end surface of the first cylindrical portion 2a in the attachment body 2 advance in a direction relatively approaching each other because screwing of the first screw portion 1a in the panel base 1 and the third screw portion 3c in the holding body 3 and screwing of the second screw portion 2d in the attachment body 2 and the fourth screw portion 3d in the holding body 3 are in directions opposite to each other, that is, have a relationship of a left screw and a right screw.

Therefore, by rotating only the holding body 3, the panel base 1 is attached to the attachment body 2 via the holding body 3, and therefore attachment work is easy.

In this way, the panel base 1 is attached to the attachment body 2 via the holding body 3, and then the first harness cable is connected to the first terminal disposed on a first end side of each of the plurality of connectors 4 attached to the panel base 1.

Next, how to detach the panel base 1 from the attachment body 2 when performing maintenance work such as inspection or repair of the second harness cable or inspection or repair of the plurality of connectors 4 or the like, or work such as connection change of the second harness cable, change of the connectors 4, laying of a new second harness cable, or removal of the second harness cable will be described.

How to detach the panel base 1 from the attachment body 2 is basically opposite to how to attach the panel base 1 to the attachment body 2 described above.

First, the first harness cable connected to the first terminal of each of the plurality of connectors 4 is detached.

Since a surface of the panel base 1, which is a first end side, is an exposed surface, it is easy to detach the first harness cable from the first terminal of the connector 4.

At this time, all the first harness cables may be detached from the first terminals of the connectors 4, or only the first harness cables minimum necessary at the time of performing maintenance work or the like may be detached.

Even detachment of the minimum necessary first harness cable does not interfere with subsequent work.

Next, only the holding body 3 is rotated counterclockwise, which is a reverse rotation to that at the time of attachment, without rotating the panel base 1.

Then, both the holding body 3 and the panel base 1 move to the second end side of the attachment body 2 from the state illustrated in FIG. 6, the first screw portion 1a of the panel base 1 is unscrewed from the third screw portion 3c of the holding body 3, and the panel base 1 can be detached from the holding body 3.

Therefore, the second harness cable can be detached from the second terminal of the connector 4, and maintenance work of the second harness cable and the plurality of connectors 4 can be performed.

The holding body 3 may keep a state of being temporarily attached to the attachment body 2 or may be detached from the attachment body 2 by rotating the holding body 3 counterclockwise.

By rotating only the holding body 3, the panel base 1 can be detached from the holding body 3, and even when there is some distance from the first flange 2b side of the attachment body 2 to a back surface of the panel base 1, the work of detaching the panel base 1 is easy, and work before maintenance work is easy.

After completion of the maintenance work, it is only required to attach the panel base 1 to the attachment body 2 via the holding body 3 in the same attachment manner as that at the time of attachment.

Note that, in the first embodiment described above, the first screw portion 1a and the third screw portion 3c each have a left screw structure, and the second screw portion 2d and the fourth screw portion 3d each have a right screw structure. Alternatively, the first screw portion 1a and the third screw portion 3c may each have a right screw structure, and the second screw portion 2d and the fourth screw portion 3d may each have a left screw structure. In short, the screwing of the first screw portion 1a and the third screw portion 3c and the screwing of the second screw portion 2d and the fourth screw portion 3d only need to have a relationship of a left screw and a right screw.

As described above, since the connector panel according to the first embodiment has a configuration in which the disk-shaped panel base 1 having the first screw portion 1a formed on an outer peripheral surface thereof is attached to the attachment body 2 via the holding body 3 having the third screw portion 3c into which the first screw portion 1a is screwed on an inner peripheral surface thereof and having the fourth screw portion 3d into which the second screw portion 2d of the attachment body 2 is screwed on the inner peripheral surface, the panel base 1 can be detached from the attachment body 2 and the panel base 1 can be attached to the attachment body 2 by a simple operation of rotating the holding body 3, and work of detachment and attachment is easy.

Moreover, since the panel base 1 can be detached from the attachment body 2 without rotating the panel base 1, the panel base 1 can be detached from the attachment body 2 without detaching the second harness cable disposed on a side where the panel base 1 is not exposed from the connector 4.

Since each of the panel base 1, the attachment body 2, and the holding body 3 is a conductive member, shielding performance can be ensured.

Since the first cylindrical portion 2a in the attachment body 2 has the first end surface in close contact with the second surface of the panel base 1 at the first end thereof, and has the even circumferential surface 2e on the outer peripheral surface thereof between the first end surface and the second screw portion 2d, the portion of the first cylindrical portion 2a having the even circumferential surface 2e serves as a buffer body when the first end surface of the first cylindrical portion 2a and the second surface of the panel base 1 are firmly in close contact with each other, and serves as a buffer body that applies a pressing force to the first cylindrical portion 2a in the second direction along the center axis and applies a pressing force to the panel base 1 in the first direction along the center axis.

As a result, the second surface of the panel base 1 and the first end surface of the first cylindrical portion 2a in the attachment body 2 are firmly in close contact with each other, and shielding performance between the panel base 1 and the holding body 3 and shielding performance between the attachment body 2 and the holding body 3 are high. As a result, shielding performance between the panel base 1 and the attachment body 2 is high.

In addition, when a screw pitch of the first screw portion 1a of the panel base 1 and the third screw portion 3c of the holding body 3 is shorter than a screw pitch of the second screw portion 2d of the attachment body 2 and the fourth screw portion 3d of the holding body 3, a moving distance of the panel base 1 can be shorter than a moving distance of the holding body 3, the panel base 1 does not need to move deep into the holding body 3, and work of connecting the first harness cable to the first terminal disposed on a first end side of each of the plurality of connectors 4 attached to the panel base 1 can be easily performed.

### Second Embodiment

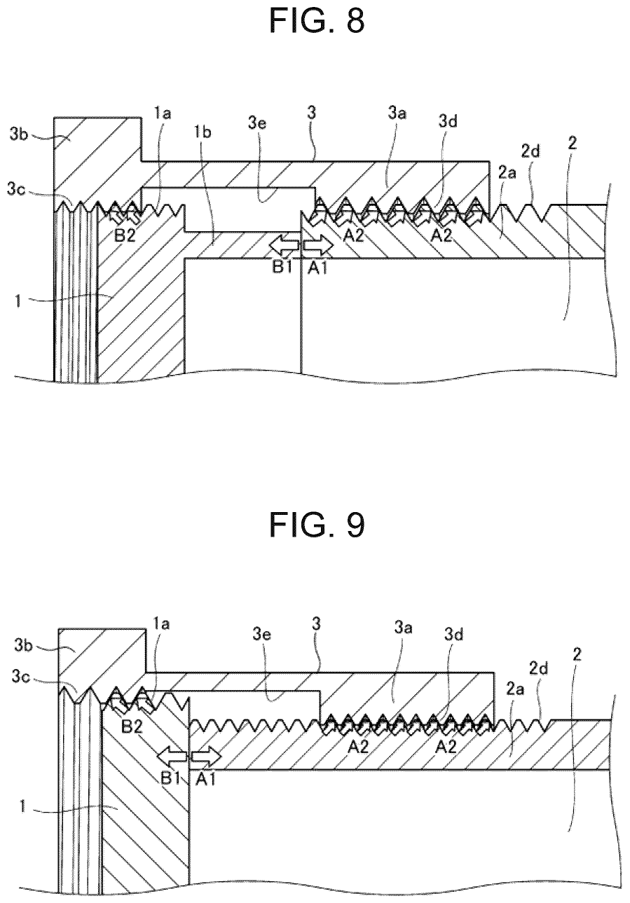

A connector panel according to a second embodiment will be described with reference to FIG. 8.

In the connector panel according to the first embodiment, the first cylindrical portion 2a in the attachment body 2 has a first end surface in close contact with a second surface of the panel base 1 at a first end thereof, a portion having the even circumferential surface 2e is formed on an outer peripheral surface thereof between the first end surface and the second screw portion 2d, and the portion having the even circumferential surface 2e has a function as a buffer body, whereas in the connector panel according to the second embodiment, a third cylindrical portion protruding from a second surface of the panel base 1 to the second surface side and having an end surface in close contact with the first end surface of the first cylindrical portion 2a in the attachment body 2 has the function as a buffer body.

In the other points, the connector panel according to the second embodiment has the same or similar configuration as the connector panel according to the first embodiment.

Note that, in FIG. 8, the same reference numerals as in FIGS. 1 to 7 denote the same or corresponding portions.

As illustrated in FIG. 8, the panel base 1 has a third cylindrical portion 1b whose center axis coincides with the center axis of the first cylindrical portion 2a in the attachment body 2 and whose thickness is the same as the thickness of the first cylindrical portion 2a.

The third cylindrical portion 1b protrudes from a second surface of the panel base 1 to the second surface side, and has an end surface in close contact with a first end surface of the first cylindrical portion 2a in the attachment body 2.

The second screw portion 2d in the first cylindrical portion 2a extends to the first end surface of the first cylindrical portion 2a.

The third cylindrical portion 1b in the panel base 1 serves as a buffer body when the end surface of the third cylindrical portion 1b and the first end surface of the first cylindrical portion 2a are firmly in close contact with each other.

That is, the third cylindrical portion 1b serves as a buffer body that applies a pressing force to the first cylindrical portion 2a in a second direction along the center axis, that is, a direction of an arrow A1 in FIG. 8, and applies a pressing force to the panel base 1 in a first direction along the center axis, that is, a direction of an arrow B1 in FIG. 8.

As a result, the second screw portion 2d of the attachment body 2 applies a pressing force to the fourth screw portion 3d of the holding body 3 in a second direction, that is, a direction of an arrow A2 in FIG. 8, and the first screw portion 1a of the panel base 1 applies a pressing force to the third screw portion 3c of the holding body 3 in a first direction, that is, a direction of an arrow B2 in FIG. 8, by a repulsive force of the third cylindrical portion 1b in the panel base 1.

Therefore, the end surface of the third cylindrical portion 1b in the panel base 1 and the first end surface of the first cylindrical portion 2a in the attachment body 2 are firmly in close contact with each other, and shielding performance between the panel base 1 and the holding body 3 and shielding performance between the attachment body 2 and the holding body 3 are high. As a result, shielding performance between the panel base 1 and the attachment body 2 is high.

Next, how to attach the connector panel according to the second embodiment to an opening which is a through hole of a wall which is a structure in an anechoic chamber is basically the same as how to attach the connector panel according to the first embodiment.

That is, the attachment is performed as follows.

The attachment body 2 is fixed to the opening formed in the wall.

The holding body 3 is temporarily attached to the attachment body 2.

The panel base 1 is temporarily attached to the holding body 3.

In this state, only the holding body 3 is rotated clockwise without rotating the panel base 1.

When only the holding body 3 is rotated clockwise without rotating the panel base 1, the holding body 3 and the panel base 1 move to a second end side of the attachment body 2 in a direction in which the end surface of the third cylindrical portion 1b in the panel base 1 and the first end surface of the first cylindrical portion 2a in the attachment body 2 approach each other.

When only the holding body 3 is further slightly rotated clockwise in a state where the end surface of the third cylindrical portion 1b in the panel base 1 and the first end surface of the first cylindrical portion 2a in the attachment body 2 are in close contact with each other, as illustrated in FIG. 8, the second screw portion 2d of the first cylindrical portion 2a in the attachment body 2 applies a pressing force to the fourth screw portion 3d of the holding body 3 in a second direction, that is, the direction of the arrow A2 in FIG. 8, and the first screw portion 1a of the panel base 1 applies a pressing force to the third screw portion 3c of the holding body 3 in a first direction, that is, the direction of the arrow B2 in FIG. 8, by a repulsive force of the third cylindrical portion 1b.

Therefore, the end surface of the third cylindrical portion 1b in the panel base 1 and the first end surface of the first cylindrical portion 2a in the attachment body 2 are firmly in close contact with each other, and shielding performance between the panel base 1 and the holding body 3 and shielding performance between the attachment body 2 and the holding body 3 are high. As a result, shielding performance between the panel base 1 and the attachment body 2 is high.

Meanwhile, how to detach the panel base 1 from the attachment body 2 when performing maintenance work such as inspection, repair, or change of the second harness cable or inspection, repair, or change of the plurality of connectors 4 is basically opposite to how to attach the panel base 1 to the attachment body 2 described above, and is basically the same as how to detach the panel base 1 from the attachment body 2 in the connector panel according to the first embodiment. Therefore, description thereof is omitted.

As described above, the connector panel according to the second embodiment is different from the connector panel according to the first embodiment in the buffer body, but has a similar effect to the connector panel according to the first embodiment.

### Third Embodiment

A connector panel according to a third embodiment will be described with reference to FIG. 9.

The connector panel according to the third embodiment is different from the connector panel according to the first embodiment in that the screw diameter of the first screw portion 1a of the panel base 1 and the third screw portion 3c of the holding body 3 is larger than the screw diameter of the second screw portion 2d of the attachment body 2 and the fourth screw portion 3d of the holding body 3 in the connector panel according to the third embodiment, whereas the screw diameter of the first screw portion 1a of the panel base 1 and the third screw portion 3c of the holding body 3 is the same as the screw diameter of the second screw portion 2d of the attachment body 2 and the third screw portion 3c of the holding body 3 in the connector panel according to the first embodiment, and has the same or similar configuration in the other points.

Note that, in FIG. 9, the same reference numerals as in FIGS. 1 to 7 denote the same or corresponding portions.

As illustrated in FIG. 9, the diameter of an outer peripheral circle including the first screw portion 1a in the panel base 1 is larger than the diameter of an outer peripheral circle including the second screw portion 2d of the first cylindrical portion 2a in the attachment body 2.

The second screw portion 2d in the first cylindrical portion 2a of the attachment body 2 extends to a first end surface of the first cylindrical portion 2a.

The first end surface of the first cylindrical portion 2a of the attachment body 2 is in close contact with a second surface of the panel base 1.

In a state where the first end surface of the first cylindrical portion 2a of the attachment body 2 and the second surface of the panel base 1 are in close contact with each other, a first end in the first cylindrical portion 2a of the attachment body 2, which is not screwed into the fourth screw portion 3d of the holding body 3, serves as a buffer body.

That is, the first end in the first cylindrical portion 2a of the attachment body 2 serves as a buffer body that applies a pressing force to the first cylindrical portion 2a in a second direction along the center axis, that is, a direction of an arrow A1 in FIG. 9, and applies a pressing force to the panel base 1 in a first direction along the center axis, that is, a direction of an arrow B1 in FIG. 9.

As a result, the second screw portion 2d of the first cylindrical portion 2a applies a pressing force to the fourth screw portion 3d of the holding body 3 in a second direction, that is, a direction of an arrow A2 in FIG. 9, and the first screw portion 1a of the panel base 1 applies a pressing force to the third screw portion 3c of the holding body 3 in a first direction, that is, a direction of an arrow B2 in FIG. 9, by a repulsive force of the first end in the first cylindrical portion 2a of the attachment body 2.

Therefore, the second surface of the panel base 1 and the first end surface of the first cylindrical portion 2a in the attachment body 2 are firmly in close contact with each other, and shielding performance between the panel base 1 and the holding body 3 and shielding performance between the attachment body 2 and the holding body 3 are high. As a result, shielding performance between the panel base 1 and the attachment body 2 is high.

Also in the connector panel according to the third embodiment, how to attach the connector panel and how to detach the panel base 1 from the attachment body 2 are basically the same as how to attach the connector panel and how to detach the panel base 1 from the attachment body 2 in the first embodiment, and therefore description thereof is omitted.

The connector panel according to the third embodiment has a similar effect to the connector panel according to the first embodiment.

### Fourth Embodiment

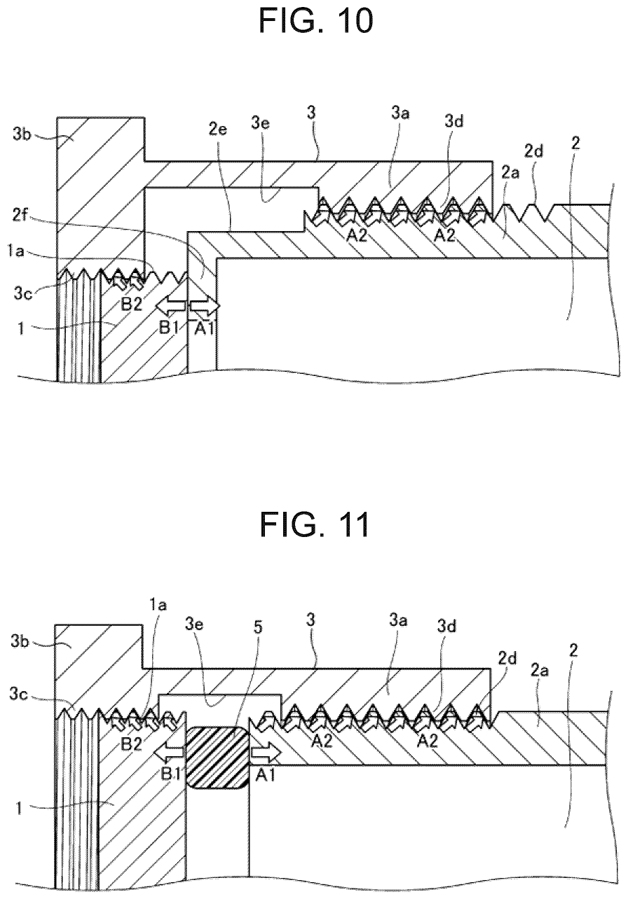

A connector panel according to a fourth embodiment will be described with reference to FIG. 10.

The connector panel according to the fourth embodiment is different from the connector panel according to the first embodiment in that the screw diameter of the second screw portion 2d of the attachment body 2 and the third screw portion 3c of the holding body 3 is larger than the screw diameter of the first screw portion 1a of the panel base 1 and the third screw portion 3c of the holding body 3 in the connector panel according to the fourth embodiment, whereas the screw diameter of the first screw portion 1a of the panel base 1 and the third screw portion 3c of the holding body 3 is the same as the screw diameter of the second screw portion 2d of the attachment body 2 and the third screw portion 3c of the holding body 3 in the connector panel according to the first embodiment, and has the same or similar configuration in the other points.

Note that, in FIG. 10, the same reference numerals as in FIGS. 1 to 7 denote the same or corresponding portions.

As illustrated in FIG. 10, the diameter of an outer peripheral circle including the second screw portion 2d of the first cylindrical portion 2a in the attachment body 2 is larger than the diameter of an outer peripheral circle including the first screw portion 1a in the panel base 1.

In the first cylindrical portion 2a of the attachment body 2, an extending portion 2f extending at a right angle inward of the portion of the first cylindrical portion 2a having the even circumferential surface 2e is formed, and a lower portion of a first end surface of the extending portion 2f is in close contact with a second surface of the panel base 1.

The portion of the first cylindrical portion 2a having the even circumferential surface 2e and the extending portion 2f serve as a buffer body when the first end surface of the extending portion 2f and the second surface of the panel base 1 are firmly in close contact with each other.

That is, the portion of the first cylindrical portion 2a having the even circumferential surface 2e and the extending portion 2f serve as a buffer body that applies a pressing force to the first cylindrical portion 2a in a second direction along the center axis, that is, a direction of an arrow A1 in FIG. 10, and applies a pressing force to the panel base 1 in a first direction along the center axis, that is, a direction of an arrow B1 in FIG. 10.

As a result, the second screw portion 2d of the first cylindrical portion 2a applies a pressing force to the fourth screw portion 3d of the holding body 3 in a second direction, that is, a direction of an arrow A2 in FIG. 10, and the first screw portion 1a of the panel base 1 applies a pressing force to the third screw portion 3c of the holding body 3 in a first direction, that is, a direction of an arrow B2 in FIG. 10, by a repulsive force of the portion of the first cylindrical portion 2a having the even circumferential surface 2e.

Therefore, a second end surface of the panel base 1 and a first end surface of the extending portion 2f of the first cylindrical portion 2a in the attachment body 2 are firmly in close contact with each other, and shielding performance between the panel base 1 and the holding body 3 and shielding performance between the attachment body 2 and the holding body 3 are high. As a result, shielding performance between the panel base 1 and the attachment body 2 is high.

Also in the connector panel according to the fourth embodiment, how to attach the connector panel and how to detach the panel base 1 from the attachment body 2 are basically the same as how to attach the connector panel and how to detach the panel base 1 from the attachment body 2 in the first embodiment, and therefore description thereof is omitted.

The connector panel according to the fourth embodiment has a similar effect to the connector panel according to the first embodiment.

### Fifth Embodiment

A connector panel according to a fifth embodiment will be described with reference to FIG. 11.

In the connector panel according to the first embodiment, the first cylindrical portion 2a in the attachment body 2 has a first end surface in close contact with a second surface of the panel base 1 at a first end thereof, a portion having the even circumferential surface 2e is formed on an outer peripheral surface thereof between the first end surface and the second screw portion 2d, and the portion having the even circumferential surface 2e has a function as a buffer body, whereas in the connector panel according to the fifth embodiment, a cylindrical elastic body disposed between the second surface of the panel base 1 and the first end surface of the first cylindrical portion 2a in close contact with both the second surface of the panel base 1 and the first end surface of the first cylindrical portion 2a has the function as a buffer body.

In the other points, the connector panel according to the fifth embodiment is the same as the connector panel according to the first embodiment.

Note that, in FIG. 11, the same reference numerals as in FIGS. 1 to 7 denote the same or corresponding portions.

As illustrated in FIG. 11, an elastic body 5 has a first end surface firmly in close contact with a second surface of the panel base 1, and a second end surface firmly in close contact with a first end surface of the first cylindrical portion 2a of the attachment body 2.

The elastic body 5 is an elastic structure having flexibility and a repulsive force, and is preferably a conductive elastic body. The conductive elastic body may be a generally known one, and is, for example, a conductive elastic body obtained by blending a conductor such as carbon black or metal powder into silicone rubber.

By using the conductive elastic body as the elastic body 5, shielding performance is improved because the panel base 1 is electrically connected and grounded via the elastic body 5.

The second screw portion 2d in the first cylindrical portion 2a extends to the first end surface of the first cylindrical portion 2a.

The holding body 3 has an even circumferential surface 3e between the third screw portion 3c and the fourth screw portion 3d on the inner peripheral surface.

The width of the even circumferential surface 3e is larger than the width of the elastic body 5, and the elastic body 5 is located at the center of the peripheral surface 3e in an axial direction in a state where the second surface of the panel base 1 and the first end surface of the first cylindrical portion 2a are in close contact with each other via the elastic body 5.

Screwing of the third screw portion 3c of the holding body 3 and the first screw portion 1a of the panel base 1 is in a direction opposite to screwing of the fourth screw portion 3d of the holding body 3 and the second screw portion 2d of the first cylindrical portion 2a of the attachment body 2, and the third screw portion 3c and the fourth screw portion 3d have a relationship of a left screw and a right screw.

A screw pitch of the first screw portion 1a and the third screw portion 3c is shorter than a screw pitch of the second screw portion 2d and the fourth screw portion 3d.

Note that the screw pitch of the first screw portion 1a and the third screw portion 3c may be the same as or longer than the screw pitch of the second screw portion 2d and the fourth screw portion 3d.

FIG. 11 illustrates a case where the screw pitch of the first screw portion 1a and the third screw portion 3c is shorter than the screw pitch of the second screw portion 2d and the fourth screw portion 3d.

A screw diameter of the first screw portion 1a and the third screw portion 3c is the same as a screw diameter of the second screw portion 2d and the fourth screw portion 3d.

Note that, as described in the third embodiment, the screw diameter of the first screw portion 1a and the third screw portion 3c may be larger than the screw diameter of the second screw portion 2d and the fourth screw portion 3d.

In addition, as described in the fourth embodiment, the screw diameter of the second screw portion 2d and the fourth screw portion 3d may be larger than the screw diameter of the first screw portion 1a and the third screw portion 3c.

Next, how to attach the connector panel according to the fifth embodiment to an opening which is a through hole of a wall which is a structure in an anechoic chamber is basically the same as how to attach the connector panel according to the first embodiment.

That is, the attachment is performed as follows.

The attachment body 2 is fixed to the opening formed in the wall.

The elastic body 5 is fixed to the first cylindrical portion 2a of the attachment body 2 via an adhesive between a first end surface of the first cylindrical portion 2a and a second end surface of the elastic body 5.

Note that the elastic body 5 may be fixed to a second surface of the panel base 1 via an adhesive between a first end surface of the elastic body 5 and the second surface of the panel base 1.

In this state, the holding body 3 is temporarily attached to the attachment body 2 in a similar manner to how to attach the connector panel according to the first embodiment.

The panel base 1 is temporarily attached to the holding body 3.

In this state, only the holding body 3 is rotated clockwise without rotating the panel base 1.

When only the holding body 3 is rotated clockwise without rotating the panel base 1, the holding body 3 and the panel base 1 move to a second end side of the attachment body 2 in a direction in which a second surface of the panel base 1 and a first end surface of the first cylindrical portion 2a in the attachment body 2 approach each other.

When only the holding body 3 is further slightly rotated clockwise in a state where the second surface of the panel base 1 is in close contact with a first end surface of the elastic body 5 and the first end surface of the first cylindrical portion 2a in the attachment body 2 is in close contact with the first end surface of the elastic body 5, as illustrated in FIG. 11, the second screw portion 2d of the first cylindrical portion 2a in the attachment body 2 applies a pressing force to the fourth screw portion 3d of the holding body 3 in a second direction, that is, a direction of an arrow A2 in FIG. 11, and the first screw portion 1a of the panel base 1 applies a pressing force to the third screw portion 3c of the holding body 3 in a first direction, that is, a direction of an arrow B2 in FIG. 11, by a repulsive force of the elastic body 5.

Therefore, the second surface of the panel base 1 and the first end surface of the first cylindrical portion 2a in the attachment body 2 are firmly in close contact with each other via the elastic body 5, and shielding performance between the panel base 1 and the holding body 3 and shielding performance between the attachment body 2 and the holding body 3 are high. As a result, shielding performance between the panel base 1 and the attachment body 2 is high.

Meanwhile, how to detach the panel base 1 from the attachment body 2 when performing maintenance work such as inspection, repair, or change of the second harness cable or inspection, repair, or change of the plurality of connectors 4 is basically opposite to how to attach the panel base 1 to the attachment body 2 described above, and is basically the same as how to detach the panel base 1 from the attachment body 2 in the connector panel according to the first embodiment. Therefore, description thereof is omitted.

As described above, the connector panel according to the fifth embodiment is different from the connector panel according to the first embodiment in the buffer body, but has a similar effect to the connector panel according to the first embodiment.

### Sixth Embodiment

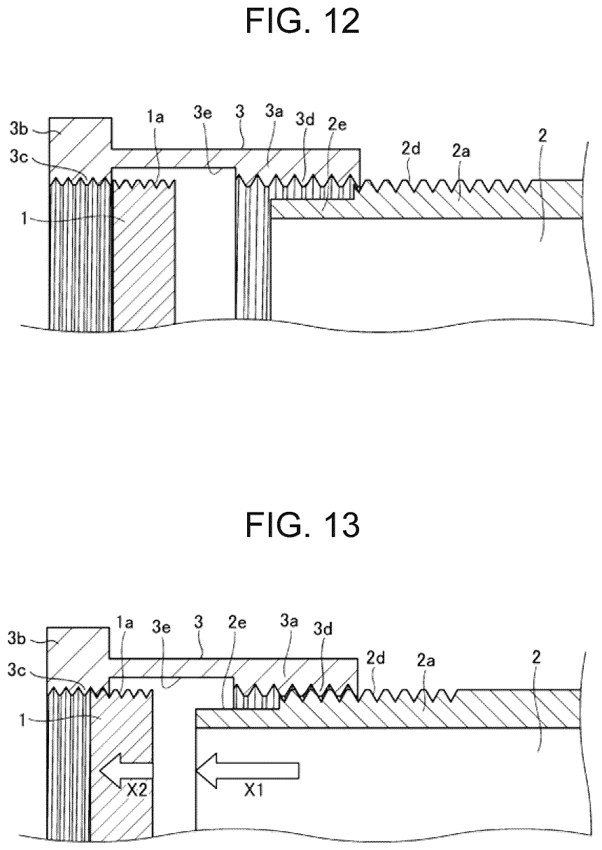

A connector panel according to a sixth embodiment will be described with reference to FIGS. 12 to 14.

The connector panel according to the sixth embodiment is different from the connector panel according to the first embodiment in that screwing of the first screw portion 1a in the panel base 1 and the third screw portion 3c in the holding body 3 is in the same direction as screwing of the second screw portion 2d in the attachment body 2 and the fourth screw portion 3d in the holding body 3, that is, a screw structure of a left screw or a right screw is adopted in the connector panel according to the sixth embodiment, whereas screwing of the first screw portion 1a in the panel base 1 and the third screw portion 3c in the holding body 3 is in a direction opposite to screwing of the second screw portion 2d in the attachment body 2 and the fourth screw portion 3d in the holding body 3 in the connector panel according to the first embodiment.

Note that, in FIGS. 12 to 14, the same reference numerals as in FIGS. 1 to 7 denote the same or corresponding portions.

How to attach the connector panel according to the sixth embodiment to an opening which is a through hole of a wall which is a structure in an anechoic chamber will be described with reference to FIGS. 12 to 14.

First, the attachment body 2 is fixed to the opening formed in the wall which is a structure. A fixing method is the same as that of the connector panel according to the first embodiment.

Meanwhile, the panel base 1 is inserted into a hollow portion having the even circumferential surface 3e in the holding body 3, and the panel base 1 is temporarily attached to the holding body 3 in a state where a part of a second end of the first screw portion 1a of the panel base 1 and a part of a first end of the third screw portion 3c of the holding body 3 are screwed into each other.

In this temporal attachment, a second surface of the panel base 1 and an open end of the holding body 3 on a first end side are caused to face each other in such a manner that center axes thereof coincide with each other, the first screw portion 1a of the panel base 1 is pressed against the third screw portion 3c of the holding body 3, and the holding body 3 is rotated counterclockwise without rotating the panel base 1.

By rotating the holding body 3 counterclockwise, the panel base 1 moves in a direction of the peripheral surface 3e in the holding body 3 and is temporarily attached.

In this state, as illustrated in FIG. 12, an open end of the holding body 3 on a second end side and an open end of the attachment body 2 on a first end side are caused to face each other in such a manner that center axes thereof coincide with each other.

Next, the fourth screw portion 3d of the holding body 3 is pressed against the second screw portion 2d of the attachment body 2, and the holding body 3 is rotated clockwise without rotating the panel base 1.

Then, as illustrated in FIG. 13, since the fourth screw portion 3d and the second screw portion 2d each have a right screw structure, the holding body 3 moves to a second end side of the attachment body 2. In other words, a first end surface of the first cylindrical portion 2a in the attachment body 2 relatively advances in a direction of a second surface of the panel base 1, that is, a direction of an arrow X1 in FIG. 13.

Meanwhile, since the first screw portion 1a and the third screw portion 3c each have a right screw structure, the panel base 1 advances in a direction away from a first end of the attachment body 2, that is, in an arrow X2 direction which is the same direction as the X1 direction in FIG. 13.

A screw pitch of the first screw portion 1a and the third screw portion 3c is shorter than a screw pitch of the second screw portion 2d and the fourth screw portion 3d.

Therefore, a moving distance of the panel base 1 per rotation in the X2 direction with respect to the holding body 3 is shorter than a moving distance of the attachment body 2 per rotation in the X1 direction with respect to the holding body 3.

As a result, the second surface of the panel base 1 and the first end surface of the first cylindrical portion 2a in the attachment body 2 gradually approach each other, and as illustrated in FIG. 14, the second surface of the panel base 1 can be brought into close contact with the first end surface of the first cylindrical portion 2a.

In addition, since the panel base 1 is not rotated when the panel base 1 is attached, the second harness cable connected to each of the plurality of connectors 4 is not twisted.

When only the holding body 3 is further slightly rotated clockwise in a close contact state, as illustrated in FIG. 14, the second screw portion 2d of the first cylindrical portion 2a in the attachment body 2 applies a pressing force to the fourth screw portion 3d of the holding body 3 in a second direction, that is, an A2 direction in FIG. 14, and the first screw portion 1a of the panel base 1 applies a pressing force to the third screw portion 3c of the holding body 3 in a first direction, that is, a B2 direction in FIG. 14, by a repulsive force of the portion of the first cylindrical portion 2a in the attachment body 2 having the even circumferential surface 2e.

Therefore, by rotating only the holding body 3, the panel base 1 is attached to the attachment body 2 via the holding body 3, and attachment work is easy.

Moreover, the second surface of the panel base 1 and the first end surface of the first cylindrical portion 2a in the attachment body 2 are firmly in close contact with each other, and shielding performance between the panel base 1 and the holding body 3 and shielding performance between the attachment body 2 and the holding body 3 are high. As a result, shielding performance between the panel base 1 and the attachment body 2 is high.

Meanwhile, how to detach the panel base 1 from the attachment body 2 when performing maintenance work such as inspection, repair, or change of the second harness cable or inspection, repair, or change of the plurality of connectors 4 is basically opposite to how to attach the panel base 1 to the attachment body 2 described above.

First, the first harness cable connected to the first terminal of each of the plurality of connectors 4 is detached.

Next, only the holding body 3 is rotated counterclockwise, which is a reverse rotation to that at the time of attachment, without rotating the panel base 1.

Then, the panel base 1 advances in a direction opposite to that at the time of attachment, and at the same time, the holding body 3 also advances in a direction opposite to that at the time of attachment.

That is, the holding body 3 moves in a direction of coming out of the attachment body 2, and the panel base 1 moves in a direction of the hollow portion having the even circumferential surface 3e in the holding body 3.

The fourth screw portion 3d of the holding body 3 is unscrewed from the second screw portion 2d of the attachment body 2, and the holding body 3 can be detached from the attachment body 2.

Therefore, the second harness cable can be detached from the second terminal of the connector 4, and maintenance work of the second harness cable and the plurality of connectors 4 can be performed.

The panel base 1 may keep a state of being temporarily attached to the hollow portion having the even circumferential surface 3e in the holding body 3, or by rotating only the holding body 3 clockwise without rotating the panel base 1, and moving the panel base 1 in a direction of a first end of the holding body 3, screwing between the first screw portion 1a and the third screw portion 3c may be released, and the panel base 1 may be detached from the holding body 3.

After completion of the maintenance work, it is only required to attach the panel base 1 to the attachment body 2 via the holding body 3 in the same attachment manner as that at the time of attachment.

The connector panel according to the sixth embodiment has a similar effect to the connector panel according to the first embodiment.

Note that, in the sixth embodiment described above, the first screw portion 1a, the third screw portion 3c, the second screw portion 2d, and the fourth screw portion 3d each have a right screw structure. Alternatively, the first screw portion 1a, the third screw portion 3c, the second screw portion 2d, and the fourth screw portion 3d may each have a left screw structure. In short, the screwing of the first screw portion 1a and the third screw portion 3c and the screwing of the second screw portion 2d and the fourth screw portion 3d only need to have the same screw structure of either a left screw or a right screw.

In addition, in the sixth embodiment described above, the screw pitch of the first screw portion 1a and the third screw portion 3c is shorter than the screw pitch of the second screw portion 2d and the fourth screw portion 3d. Alternatively, the screw pitch of the second screw portion 2d and the fourth screw portion 3d may be shorter than the screw pitch of the first screw portion 1a and the third screw portion 3c.

In this case, by pressing the fourth screw portion 3d of the holding body 3 against the second screw portion 2d of the attachment body 2 and rotating the holding body 3 clockwise, the holding body 3 is moved until an end surface of the third screw portion 3c of the holding body 3 on a second side is located on a first end surface of the first cylindrical portion 2a of the attachment body 2, and temporarily attached to the attachment body 2.

In this state, a second surface of the panel base 1 and an open end of the holding body 3 on a first end side are caused to face each other in such a manner that center axes thereof coincide with each other, the first screw portion 1a of the panel base 1 is pressed against the third screw portion 3c of the holding body 3, and the holding body 3 is rotated counterclockwise without rotating the panel base 1.

Since a moving distance of the panel base 1 per rotation with respect to the holding body 3 is longer than a moving distance of the attachment body 2 per rotation with respect to the holding body 3, the second surface of the panel base 1 and the first end surface of the first cylindrical portion 2a in the attachment body 2 gradually approach each other, and the second surface of the panel base 1 can be brought into close contact with the first end surface of the first cylindrical portion 2a.

### Seventh Embodiment

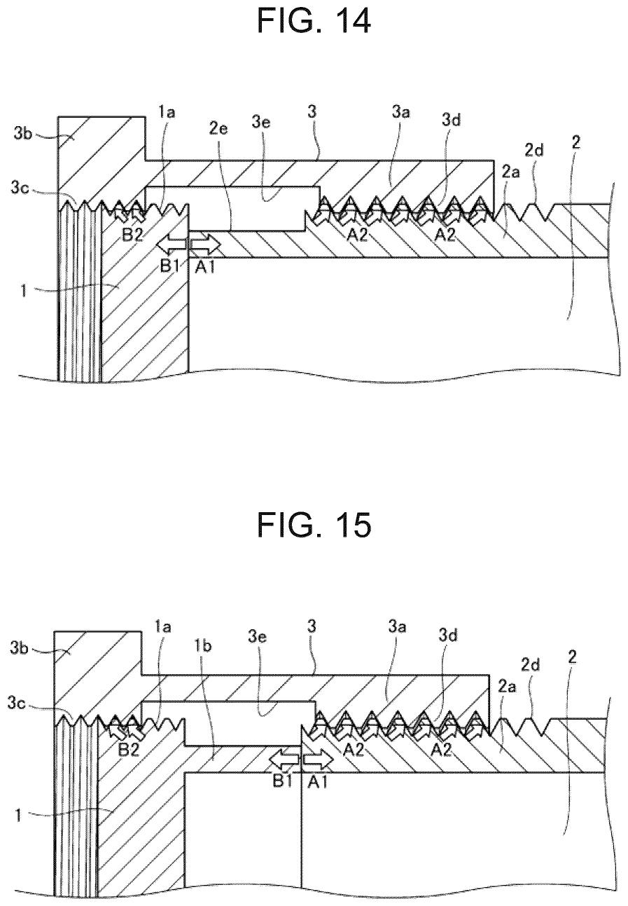

A connector panel according to a seventh embodiment will be described with reference to FIG. 15.

In the connector panel according to the sixth embodiment, the first cylindrical portion 2a in the attachment body 2 has a first end surface in close contact with a second surface of the panel base 1 at a first end thereof, a portion having the even circumferential surface 2e is formed on the outer peripheral surface between the first end surface and the second screw portion 2d, and the portion having the even circumferential surface 2e has a function as a buffer body, whereas in the connector panel according to the seventh embodiment, a third cylindrical portion protruding from a second surface of the panel base 1 to the second surface side and having an end surface in close contact with a first end surface of the first cylindrical portion 2a in the attachment body 2 has the function as a buffer body.

In the other points, the connector panel according to the seventh embodiment has the same or similar configuration as the connector panel according to the sixth embodiment.

Note that, in FIG. 15, the same reference numerals as in FIGS. 12 to 14 denote the same or corresponding portions.

As illustrated in FIG. 15, the panel base 1 has a third cylindrical portion 1b whose center axis coincides with the center axis of the first cylindrical portion 2a in the attachment body 2 and whose thickness is the same as the thickness of the first cylindrical portion 2a.

The third cylindrical portion 1b protrudes from a second surface of the panel base 1 to the second surface side, and has an end surface in close contact with a first end surface of the first cylindrical portion 2a in the attachment body 2.

The second screw portion 2d in the first cylindrical portion 2a extends to the first end surface of the first cylindrical portion 2a.

The third cylindrical portion 1b in the panel base 1 serves as a buffer body when the end surface of the third cylindrical portion 1b and the first end surface of the first cylindrical portion 2a are firmly in close contact with each other.

That is, the third cylindrical portion 1b serves as a buffer body that applies a pressing force to the first cylindrical portion 2a in a second direction along the center axis, that is, a direction of an arrow A1 in FIG. 15, and applies a pressing force to the panel base 1 in a first direction along the center axis, that is, a direction of an arrow B1 in FIG. 15.

As a result, the second screw portion 2d of the attachment body 2 applies a pressing force to the fourth screw portion 3d of the holding body 3 in a second direction, that is, a direction of an arrow A2 in FIG. 15, and the first screw portion 1a of the panel base 1 applies a pressing force to the third screw portion 3c of the holding body 3 in a first direction, that is, a direction of an arrow B2 in FIG. 15, by a repulsive force of the third cylindrical portion 1b in the panel base 1.

Therefore, the end surface of the third cylindrical portion 1b in the panel base 1 and the first end surface of the first cylindrical portion 2a in the attachment body 2 are firmly in close contact with each other, and shielding performance between the panel base 1 and the holding body 3 and shielding performance between the attachment body 2 and the holding body 3 are high. As a result, shielding performance between the panel base 1 and the attachment body 2 is high.

Next, how to attach the connector panel according to the seventh embodiment to an opening which is a through hole of a wall which is a structure in an anechoic chamber is basically the same as how to attach the connector panel according to the sixth embodiment.

That is, the attachment is performed as follows.

The attachment body 2 is fixed to the opening formed in the wall.

The panel base 1 is inserted into a hollow portion having the even circumferential surface 3e in the holding body 3 and temporarily attached.

In this state, an open end of the holding body 3 on a second end side and an open end of the attachment body 2 on a first end side are caused to face each other in such a manner that center axes thereof coincide with each other, and only the holding body 3 is rotated clockwise without rotating the panel base 1.

When only the holding body 3 is rotated clockwise without rotating the panel base 1, the holding body 3 moves to a second end side of the attachment body 2, and the panel base 1 moves in a direction away from a first end of the attachment body 2. However, a second surface of the panel base 1 and a first end surface of the first cylindrical portion 2a in the attachment body 2 gradually approach each other, and the second surface of the panel base 1 is brought into close contact with the first end surface of the first cylindrical portion 2a.

When only the holding body 3 is further slightly rotated clockwise in a close contact state, as illustrated in FIG. 15, the second screw portion 2d of the first cylindrical portion 2a in the attachment body 2 applies a pressing force to the fourth screw portion 3d of the holding body 3 in a second direction, that is, a direction of an arrow A2 in FIG. 15, and the first screw portion 1a of the panel base 1 applies a pressing force to the third screw portion 3c of the holding body 3 in a first direction, that is, a direction of an arrow B2 in FIG. 15, by a repulsive force of the third cylindrical portion 1b.

Therefore, the end surface of the third cylindrical portion 1b in the panel base 1 and the first end surface of the first cylindrical portion 2a in the attachment body 2 are firmly in close contact with each other, and shielding performance between the panel base 1 and the holding body 3 and shielding performance between the attachment body 2 and the holding body 3 are high. As a result, shielding performance between the panel base 1 and the attachment body 2 is high.

Meanwhile, how to detach the panel base 1 from the attachment body 2 when performing maintenance work such as inspection, repair, or change of the second harness cable or inspection, repair, or change of the plurality of connectors 4 is basically opposite to how to attach the panel base 1 to the attachment body 2 described above, and is basically the same as how to detach the panel base 1 from the attachment body 2 in the connector panel according to the sixth embodiment. Therefore, description thereof is omitted.

As described above, the connector panel according to the seventh embodiment is different from the connector panel according to the sixth embodiment in the buffer body, but has a similar effect to the connector panel according to the sixth embodiment. Eighth embodiment.

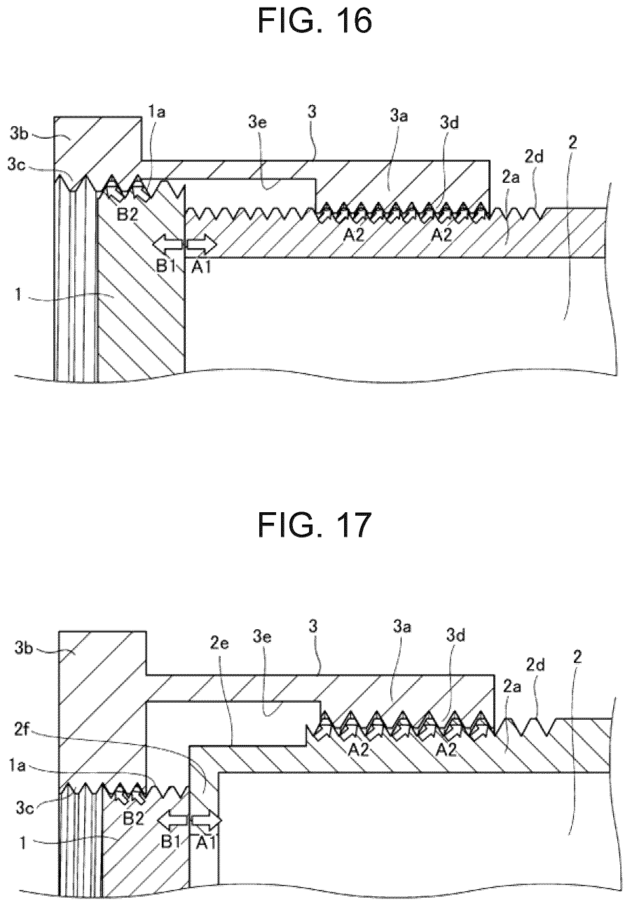

A connector panel according to an eighth embodiment will be described with reference to FIG. 16.

The connector panel according to the eighth embodiment is different from the connector panel according to the sixth embodiment in that the screw diameter of the first screw portion 1a of the panel base 1 and the third screw portion 3c of the holding body 3 is larger than the screw diameter of the second screw portion 2d of the attachment body 2 and the fourth screw portion 3d of the holding body 3 in the connector panel according to the eighth embodiment, whereas the screw diameter of the first screw portion 1a of the panel base 1 and the third screw portion 3c of the holding body 3 is the same as the screw diameter of the second screw portion 2d of the attachment body 2 and the third screw portion 3c of the holding body 3 in the connector panel according to the sixth embodiment, and has the same or similar configuration in the other points.

Note that, in FIG. 16, the same reference numerals as in FIGS. 12 to 14 denote the same or corresponding portions.

As illustrated in FIG. 16, the diameter of an outer peripheral circle including the first screw portion 1a in the panel base 1 is larger than the diameter of an outer peripheral circle including the second screw portion 2d of the first cylindrical portion 2a in the attachment body 2.

The second screw portion 2d in the first cylindrical portion 2a of the attachment body 2 extends to a first end surface of the first cylindrical portion 2a.

The first end surface of the first cylindrical portion 2a of the attachment body 2 is in close contact with a second surface of the panel base 1.

In a state where the first end surface of the first cylindrical portion 2a of the attachment body 2 and the second surface of the panel base 1 are in close contact with each other, a first end in the first cylindrical portion 2a of the attachment body 2, which is not screwed into the fourth screw portion 3d of the holding body 3, serves as a buffer body.

That is, the first end in the first cylindrical portion 2a of the attachment body 2 serves as a buffer body that applies a pressing force to the first cylindrical portion 2a in a second direction along the center axis, that is, a direction of an arrow A1 in FIG. 16, and applies a pressing force to the panel base 1 in a first direction along the center axis, that is, a direction of an arrow B1 in FIG. 16.

As a result, the second screw portion 2d of the first cylindrical portion 2a applies a pressing force to the fourth screw portion 3d of the holding body 3 in a second direction, that is, a direction of an arrow A2 in FIG. 16, and the first screw portion 1a of the panel base 1 applies a pressing force to the third screw portion 3c of the holding body 3 in a first direction, that is, a direction of an arrow B2 in FIG. 16, by a repulsive force of the first end in the first cylindrical portion 2a of the attachment body 2.

Therefore, the second surface of the panel base 1 and the first end surface of the first cylindrical portion 2a in the attachment body 2 are firmly in close contact with each other, and shielding performance between the panel base 1 and the holding body 3 and shielding performance between the attachment body 2 and the holding body 3 are high. As a result, shielding performance between the panel base 1 and the attachment body 2 is high.

Also in the connector panel according to the eighth embodiment, how to attach the connector panel and how to detach the panel base 1 from the attachment body 2 are basically the same as how to attach the connector panel and how to detach the panel base 1 from the attachment body 2 in the sixth embodiment, and therefore description thereof is omitted.

The connector panel according to the eighth embodiment has a similar effect to the connector panel according to the sixth embodiment.

### Ninth Embodiment

A connector panel according to a ninth embodiment will be described with reference to FIG. 17.

The connector panel according to the ninth embodiment is different from the connector panel according to the sixth embodiment in that the screw diameter of the second screw portion 2d of the attachment body 2 and the fourth screw portion 3d of the holding body 3 is larger than the screw diameter of the first screw portion 1a of the panel base 1 and the third screw portion 3c of the holding body 3 in the connector panel according to the ninth embodiment, whereas the screw diameter of the first screw portion 1a of the panel base 1 and the third screw portion 3c of the holding body 3 is the same as the screw diameter of the second screw portion 2d of the attachment body 2 and the fourth screw portion 3d of the holding body 3 in the connector panel according to the sixth embodiment, and has the same or similar configuration in the other points.

Note that, in FIG. 17, the same reference numerals as in FIGS. 12 to 14 denote the same or corresponding portions.

As illustrated in FIG. 17, the diameter of an outer peripheral circle including the second screw portion 2d of the first cylindrical portion 2a in the attachment body 2 is larger than the diameter of an outer peripheral circle including the first screw portion 1a in the panel base 1.

In the first cylindrical portion 2a of the attachment body 2, an extending portion 2f extending at a right angle inward of the portion of the first cylindrical portion 2a having the even circumferential surface 2e is formed, and a lower portion of a first end surface of the extending portion 2f is in close contact with a second surface of the panel base 1.

The portion of the first cylindrical portion 2a having the even circumferential surface 2e and the extending portion 2f serve as a buffer body when the first end surface of the extending portion 2f and the second surface of the panel base 1 are firmly in close contact with each other.

That is, the portion of the first cylindrical portion 2a having the even circumferential surface 2e and the extending portion 2f serve as a buffer body that applies a pressing force to the first cylindrical portion 2a in a second direction along the center axis, that is, a direction of an arrow A1 in FIG. 17, and applies a pressing force to the panel base 1 in a first direction along the center axis, that is, a direction of an arrow B1 in FIG. 17.

As a result, the second screw portion 2d of the first cylindrical portion 2a applies a pressing force to the fourth screw portion 3d of the holding body 3 in a second direction, that is, a direction of an arrow A2 in FIG. 17, and the first screw portion 1a of the panel base 1 applies a pressing force to the third screw portion 3c of the holding body 3 in a first direction, that is, a direction of an arrow B2 in FIG. 17, by a repulsive force of the portion of the first cylindrical portion 2a having the even circumferential surface 2e.

Therefore, a second end surface of the panel base 1 and a first end surface of the extending portion 2f of the first cylindrical portion 2a in the attachment body 2 are firmly in close contact with each other, and shielding performance between the panel base 1 and the holding body 3 and shielding performance between the attachment body 2 and the holding body 3 are high. As a result, shielding performance between the panel base 1 and the attachment body 2 is high.

In addition, since the screw diameter of the fourth screw portion 3d of the holding body 3 is larger than the screw diameter of the third screw portion 3c, the panel base 1 can be temporarily attached to the holding body 3 from the third screw portion 3c side, and therefore the panel base 1 can be easily temporarily attached to the holding body 3.

In the connector panel according to the ninth embodiment, how to attach the connector panel after the panel base 1 is temporarily attached to the holding body 3 is basically the same as how to attach the connector panel according to the sixth embodiment, and therefore description of how to attach the connector panel after the panel base 1 is temporarily attached to the holding body 3 is omitted.

In addition, in the connector panel according to the ninth embodiment, how to detach the panel base 1 from the attachment body 2 is basically the same as how to detach the panel base 1 from the attachment body 2 in the connector panel according to the sixth embodiment, and therefore description of how to detach the panel base 1 from the attachment body 2 is omitted.

The connector panel according to the ninth embodiment has a similar effect to the connector panel according to the sixth embodiment, and facilitates temporary attachment of the panel base 1 to the holding body 3.

### Tenth Embodiment

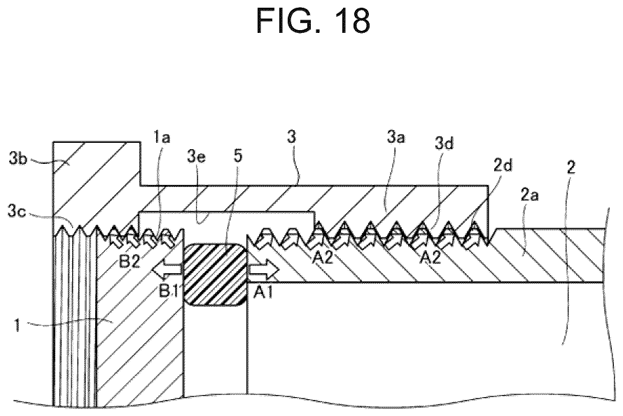

A connector panel according to a tenth embodiment will be described with reference to FIG. 18.

In the connector panel according to the sixth embodiment, the first cylindrical portion 2a in the attachment body 2 has a first end surface in close contact with a second surface of the panel base 1 at a first end thereof, a portion having the even circumferential surface 2e is formed on an outer peripheral surface thereof between the first end surface and the second screw portion 2d, and the portion having the even circumferential surface 2e has a function as a buffer body, whereas in the connector panel according to the tenth embodiment, a cylindrical elastic body disposed between the second surface of the panel base 1 and the first end surface of the first cylindrical portion 2a in close contact with both the second surface of the panel base 1 and the first end surface of the first cylindrical portion 2a has the function as a buffer body.

In the other points, the connector panel according to the tenth embodiment is the same as the connector panel according to the sixth embodiment.

Note that, in FIG. 18, the same reference numerals as in FIGS. 12 to 14 denote the same or corresponding portions.

As illustrated in FIG. 18, an elastic body 5 has a first end surface firmly in close contact with a second surface of the panel base 1, and a second end surface firmly in close contact with a first end surface of the first cylindrical portion 2a of the attachment body 2.

The elastic body 5 is an elastic structure having flexibility and a repulsive force, and is preferably a conductive elastic body. The conductive elastic body may be a generally known one, and is, for example, a conductive elastic body obtained by blending a conductor such as carbon black or metal powder into silicone rubber.

By using the conductive elastic body as the elastic body 5, shielding performance is improved because the panel base 1 is electrically connected and grounded via the elastic body 5.

The second screw portion 2d in the first cylindrical portion 2a extends to the first end surface of the first cylindrical portion 2a.

The holding body 3 has an even circumferential surface 3e between the third screw portion 3c and the fourth screw portion 3d on the inner peripheral surface.

The width of the even circumferential surface 3e is larger than the width of the elastic body 5, and similarly to the connector panel according to the sixth embodiment, the even circumferential surface 3e has a width necessary for temporarily attaching the panel base 1 to the holding body 3.

The elastic body 5 is located at the center of the peripheral surface 3e in an axial direction in a state where a second surface of the panel base 1 and a first end surface of the first cylindrical portion 2a are in close contact with each other via the elastic body 5.

Screwing of the third screw portion 3c of the holding body 3 and the first screw portion 1a of the panel base 1 is in the same direction as screwing of the fourth screw portion 3d of the holding body 3 and the second screw portion 2d of the first cylindrical portion 2a of the attachment body 2, and the third screw portion 3c and the fourth screw portion 3d each have a right screw structure.

Note that the third screw portion 3c and the fourth screw portion 3d may each have a left screw structure, and in this case, a rotation direction is opposite to that of the right screw structure.

A screw pitch of the first screw portion 1a and the third screw portion 3c is shorter than a screw pitch of the second screw portion 2d and the fourth screw portion 3d.

A screw diameter of the first screw portion 1a and the third screw portion 3c is the same as a screw diameter of the second screw portion 2d and the fourth screw portion 3d.

Note that, as described in the eighth embodiment, the screw diameter of the first screw portion 1a and the third screw portion 3c may be larger than the screw diameter of the second screw portion 2d and the fourth screw portion 3d.

In addition, as described in the ninth embodiment, the screw diameter of the second screw portion 2d and the fourth screw portion 3d may be larger than the screw diameter of the first screw portion 1a and the third screw portion 3c.

Next, how to attach the connector panel according to the tenth embodiment to an opening which is a through hole of a wall which is a structure in an anechoic chamber is basically the same as how to attach the connector panel according to the sixth embodiment.

That is, the attachment is performed as follows.

The attachment body 2 is fixed to the opening formed in the wall.

The elastic body 5 is fixed to the first cylindrical portion 2a of the attachment body 2 via an adhesive between a first end surface of the first cylindrical portion 2a and a second end surface of the elastic body 5.

Note that the elastic body 5 may be fixed to a second surface of the panel base 1 via an adhesive between a first end surface of the elastic body 5 and the second surface of the panel base 1.

The panel base 1 is inserted into a hollow portion having the even circumferential surface 3e in the holding body 3 and temporarily attached.

In this state, only the holding body 3 is rotated clockwise without rotating the panel base 1.

In this state, an open end of the holding body 3 on a second end side and an open end of the attachment body 2 on a first end side are caused to face each other in such a manner that center axes thereof coincide with each other, and only the holding body 3 is rotated clockwise without rotating the panel base 1.

When only the holding body 3 is rotated clockwise without rotating the panel base 1, the holding body 3 moves to a second end side of the attachment body 2, and the panel base 1 moves in a direction away from a first end of the attachment body 2. However, a second surface of the panel base 1 and a first end surface of the first cylindrical portion 2a in the attachment body 2 gradually approach each other, and the second surface of the panel base 1 is brought into close contact with the first end surface of the first cylindrical portion 2a.

When only the holding body 3 is further slightly rotated clockwise in a close contact state, as illustrated in FIG. 18, the second screw portion 2d of the first cylindrical portion 2a in the attachment body 2 applies a pressing force to the fourth screw portion 3d of the holding body 3 in a second direction, that is, a direction of an arrow A2 in FIG. 18, and the first screw portion 1a of the panel base 1 applies a pressing force to the third screw portion 3c of the holding body 3 in a first direction, that is, a direction of an arrow B2 in FIG. 18, by a repulsive force of the elastic body 5.

Therefore, the second surface of the panel base 1 and the first end surface of the first cylindrical portion 2a in the attachment body 2 are firmly in close contact with each other via the elastic body 5, and shielding performance between the panel base 1 and the holding body 3 and shielding performance between the attachment body 2 and the holding body 3 are high. As a result, shielding performance between the panel base 1 and the attachment body 2 is high.

Meanwhile, how to detach the panel base 1 from the attachment body 2 when performing maintenance work such as inspection, repair, or change of the second harness cable or inspection, repair, or change of the plurality of connectors 4 is basically opposite to how to attach the panel base 1 to the attachment body 2 described above, and is basically the same as how to detach the panel base 1 from the attachment body 2 in the connector panel according to the sixth embodiment. Therefore, description thereof is omitted.

As described above, the connector panel according to the tenth embodiment is different from the connector panel according to the sixth embodiment in the buffer body, but has a similar effect to the connector panel according to the sixth embodiment.

Note that the embodiments can be freely combined to each other, any constituent element in each of the embodiments can be modified, or any constituent element in each of the embodiments can be omitted.

### INDUSTRIAL APPLICABILITY

The connector panel according to the present disclosure is suitable for a structure shielding an inside from an outside, in particular, a connector panel that is attached to an opening formed in a wall shielding an inside of a shielded closed space such as an anechoic chamber from an outside thereof, and electrically connects the inside of the closed space to the outside thereof with a plurality of signal cables or the like.

### REFERENCE SIGNS LIST

1: panel base, 1a: first screw portion, 1b: third cylindrical portion, 2: attachment body, 2a: first cylindrical portion, 2b: flange, 2c: screw through hole, 2d: second screw portion, 2e: even circumferential surface, 2f: extending portion, 3: holding body, 3a: second cylindrical portion, 3b: second flange, 3c: third screw portion, 3d: fourth screw portion, 3e: even circumferential surface, 4: connector, 5: elastic body

1. A connector panel comprising:
a panel base having a disk shape to which a plurality of connectors is attached, the plurality of connectors each having a first end protruding to a side of a first surface of the panel base and a second end protruding to a side of a second surface of the panel base, the panel base having a first screw portion on its outer peripheral surface;
an attachment body having a first cylindrical portion and a flange formed integrally with the first cylindrical portion at a second end of the first cylindrical portion, the flange being configured to be fixed to an edge of an opening formed in a structure shielding an inside from an outside, and having a second screw portion at a first end of an outer peripheral surface of the first cylindrical portion; and
a holding body having a third screw portion into which the first screw portion of the panel base is screwed at a first end of an inner peripheral surface of the holding body and a fourth screw portion into which the second screw portion of the attachment body is screwed at a second end of the inner peripheral surface, and having a second cylindrical portion whose center axis coincides with a center axis of the first cylindrical portion of the attachment body.

2. The connector panel according to claim 1, wherein each of the panel base, the attachment body, and the holding body is a conductive member.

3. The connector panel according to claim 2, wherein
the first screw portion in the panel base is a parallel male screw,
the second screw portion in the attachment body is a parallel male screw,
the third screw portion in the holding body is a parallel female screw, and the fourth screw portion in the holding body is a parallel female screw, and
screwing of the first screw portion and the third screw portion is in a direction opposite to screwing of the second screw portion and the fourth screw portion.

4. The connector panel according to claim 3, wherein a screw pitch of the first screw portion and the third screw portion is shorter than a screw pitch of the second screw portion and the fourth screw portion.

5. The connector panel according to claim 3, wherein a screw diameter of the first screw portion and the third screw portion is larger than a screw diameter of the second screw portion and the fourth screw portion.

6. The connector panel according to claim 4, wherein a screw diameter of the first screw portion and the third screw portion is larger than a screw diameter of the second screw portion and the fourth screw portion.

7. The connector panel according to claim 3, wherein a screw diameter of the second screw portion and the fourth screw portion is larger than a screw diameter of the first screw portion and the third screw portion.

8. The connector panel according to claim 4, wherein a screw diameter of the second screw portion and the fourth screw portion is larger than a screw diameter of the first screw portion and the third screw portion.

9. The connector panel according to claim 3, further comprising a cylindrical elastic body whose first end surface is to be in close contact with the second surface of the panel base and whose second end surface is to be in close contact with a first end surface of the first cylindrical portion of the attachment body.

10. The connector panel according to claim 1, wherein the holding body has an even circumferential surface serving as a boundary between the third screw portion and the fourth screw portion on an inner peripheral surface of the holding body.

11. The connector panel according to claim 10, wherein the first cylindrical portion of the attachment body has an end surface to be in close contact with the second surface of the panel base at a first end of the first cylindrical portion, and has an even circumferential surface on an outer peripheral surface of the first cylindrical portion between the end surface to be in close contact and the second screw portion.

12. The connector panel according to claim 10, wherein the panel base has a third cylindrical portion protruding from the second surface of the panel base in a direction from the first surface to the second surface of the panel base, and having an end surface to be in close contact with a first end surface of the first cylindrical portion of the attachment body.

13. The connector panel according to claim 2, wherein
the first screw portion in the panel base is a parallel male screw,
the second screw portion in the attachment body is a parallel male screw,
the third screw portion in the holding body is a parallel female screw, and the fourth screw portion in the holding body is a parallel female screw,
screwing of the first screw portion and the third screw portion is in a same direction as screwing of the second screw portion and the fourth screw portion, and
a screw pitch of the first screw portion and the third screw portion is different from a screw pitch of the second screw portion and the fourth screw portion.

14. The connector panel according to claim 13, wherein a screw diameter of the first screw portion and the third screw portion is larger than a screw diameter of the second screw portion and the fourth screw portion.

15. The connector panel according to claim 13, wherein a screw diameter of the first screw portion and the third screw portion is smaller than a screw diameter of the second screw portion and the fourth screw portion.

16. The connector panel according to claim 13, further comprising a cylindrical elastic body whose first end surface is to be in close contact with a second surface of the panel base and whose second end surface is to be in close contact with a first end surface of the first cylindrical portion of the attachment body.

17. The connector panel according to claim 13, wherein the holding body has an even circumferential surface serving as a boundary between the third screw portion and the fourth screw portion on an inner peripheral surface of the holding body.

18. The connector panel according to claim 17, wherein the first cylindrical portion of the attachment body has an end surface to be in close contact with a second surface of the panel base at a first end of the first cylindrical portion, and has an even circumferential surface on an outer peripheral surface of the first cylindrical portion between the end surface and the second screw portion.

19. The connector panel according to claim 17, wherein the panel base has a third cylindrical portion protruding to the side of the second surface, and having an end surface to be in close contact with a first end surface of the first cylindrical portion of the attachment body.
